(19) United States
(12) Patent Application Publication
(10) Pub. No.: US 2015/0360122 A1
(43) Pub. Date: Dec. 17, 2015

(54) ACOUSTIC ENERGY INDUCTIVE DEVICE, EQUIPMENT AND METHOD USING THE SAME

(71) Applicant: TAIWAN TEXTILE RESEARCH INSTITUTE, NEW TAIPEI CITY (TW)

(72) Inventors: Yi-Yuan Chen, TU-CHEN CITY (TW); Cheng-Tung Chang, TU-CHEN CITY (TW); Chien-Lung Shen, TU-CHEN CITY (TW)

(21) Appl. No.: 14/460,663

(22) Filed: Aug. 15, 2014

(30) Foreign Application Priority Data
Jun. 13, 2014 (TW) 103120551

(51) Int. Cl. A63F 9/02; H04R 1/02; H04B 11/00; H04R 1/28

(52) U.S. Cl. CPC A63F 9/02; H04R 1/2807; H04R 1/028; H04B 11/00; H04R 2201/023

(57) ABSTRACT

An acoustic energy inductive device includes a first fabric, a second fabric, and a microphone. The second fabric and the first fabric are combined such that a resonant chamber is formed between the first fabric and the second fabric. The microphone is disposed in the resonant chamber for converting a sonic signal in the resonant chamber into an electrical signal. The first fabric and the second fabric are made of impermeable material.

### RELATED APPLICATIONS

This application claims priority to Taiwanese Application Serial Number 103120551, filed Jun. 13, 2014, which is herein incorporated by reference.

### BACKGROUND

1. Field of Invention

The present invention relates to a detector. More particularly, the present invention relates to a wearable detector that utilizes inducting acoustic energy.

2. Description of Related Art

More and more people have been taking part in outdoor activities in recent years. War games (or survival games) played with toy guns are becoming increasingly popular worldwide. Therefore, related wearable equipment like helmets, bullet-proof vests, and gloves have been introduced for use as an integral part of such war games. In addition to seeking excitement, those participating in war games enjoy the competition involved, and such competition is facilitated by keeping track of the number of gun hits on the participants.

Therefore, a counter for counting the gun hits is usually disposed on the wearable equipment used in war games. In addition to exact count of gun hits, such wearable equipment must be light and comfortable, such that the agility of the competitors is not hindered. For these reasons, those in the field have been endeavoring to find ways in which to make wearable equipment that can precisely detect gun hits and is at the same time lightweight.

### SUMMARY

An aspect of the present invention provides an acoustic energy inductive device that utilizes a sonic wave resulting from an object hitting another object as a detective source, and noise is effectively eliminated through a resonant chamber formed by fabrics such that the detection can be more exact. The acoustic energy inductive device of the present invention can be applied to a wearable equipment used in war games (or survival games), and through the lightweight property of the acoustic energy inductive device, a user is able to move agilely.

An aspect of the present invention provides an acoustic energy inductive device including a first fabric, a second fabric, and a microphone. The second fabric and the first fabric are combined such that a resonant chamber is formed between the first fabric and the second fabric. The microphone is disposed in the resonant chamber for converting a sonic signal in the resonant chamber into an electrical signal. The first fabric and the second fabric are made of impermeable material.

In one or more embodiments, the first fabric is a composite fabric layer with multiple sub-layers.

In one or more embodiments, the first fabric is made of a composite neoprene fabric, a composite polyvinyl chloride (PVC) film fabric, a non-woven fabric or combinations thereof.

In one or more embodiments, the second fabric is made of a composite neoprene fabric, a composite polyvinyl chloride (PVC) film fabric, a non-woven fabric or combinations thereof.

In one or more embodiments, the acoustic energy inductive device further includes a processing circuit. The processing circuit is used for determining whether to send a control signal according to the electrical signal.

In one or more embodiments, the acoustic energy inductive device further includes a sensing signal generator. The sensing signal generator is used for sending a sensing signal according to the control signal.

In one or more embodiments, the processing circuit includes a converter and a transmission device. The converter is used for determining a duration time of the electrical signal in a predetermined level range. The transmission device is used for sending the control signal when the duration time is in a predetermined time range.

In one or more embodiments, the acoustic energy inductive device further includes an amplifier for amplifying the electrical signal.

An aspect of the present invention provides a wearable equipment including a body and the acoustic energy inductive device. The acoustic energy inductive device is disposed on the body.

In one or more embodiments, the body is a vest.

In one or more embodiments, the body is a helmet.

In one or more embodiments, the acoustic energy inductive device is detachably disposed on the body.

An aspect of the present invention provides a method for inducting an acoustic energy including converting sonic signal in a resonant chamber into an electrical signal via a microphone disposed in the resonant chamber. The resonant chamber is formed between a first fabric and a second fabric.

In one or more embodiments, the method further includes determining whether to send a control signal according to the electrical signal and sending a sensing signal according to the control signal.

In one or more embodiments, determining whether to send a control signal includes determining a duration time of the electrical signal in a predetermined level range and sending the control signal when the duration time is in a predetermined time range.

In one or more embodiments, a lower limit value of the predetermined level range is about 5 mv, and an upper limit value of the predetermined level range is about 15 mv.

In one or more embodiments, the predetermined time range is about 3 μs to 10 μs.

The acoustic energy inductive device of the present invention uses the resonant chamber formed by fabrics for eliminating noise, such that the detection can be more exact. Furthermore, the acoustic energy inductive device of the present invention includes the processing circuit for performing additional conversion of a detection signal, such that high sensitivity with respect to a target object is realized.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an exploded perspective diagram of an acoustic energy inductive device according to an embodiment of the present invention;

FIG. 2A is a waveform schematic diagram of a sonic signal that has not passed into a resonant chamber of the acoustic energy inductive device of the present invention;

FIG. 2B is a waveform schematic diagram of a sonic signal that has passed into the resonant chamber of the acoustic energy inductive device of the present invention;

FIG. 3 is a side view of an acoustic energy inductive device according to an embodiment of the present invention;

FIG. 4A to FIG. 4D are schematic diagrams of a converting process by a processing circuit of an acoustic energy inductive device of the present invention;

FIG. 5 is a flow chart of a detecting method of an acoustic energy inductive device according to an embodiment of the present invention;

FIG. 6 is a schematic diagram of a wearable equipment according to an embodiment of the present invention; and

FIG. 7 is a schematic diagram of a wearable equipment according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

An aspect of the present invention provides an acoustic energy inductive device using a resonant chamber formed by fabrics for eliminating noise, such that the main frequency of a sonic wave can be detected more precisely. Thus, the effect of filtering the sonic wave is achieved by structure, such that an extra circuit is not necessary. Furthermore, because the acoustic energy inductive device of the present invention is mainly formed by fabrics, the overall device is lightweight and flexible.

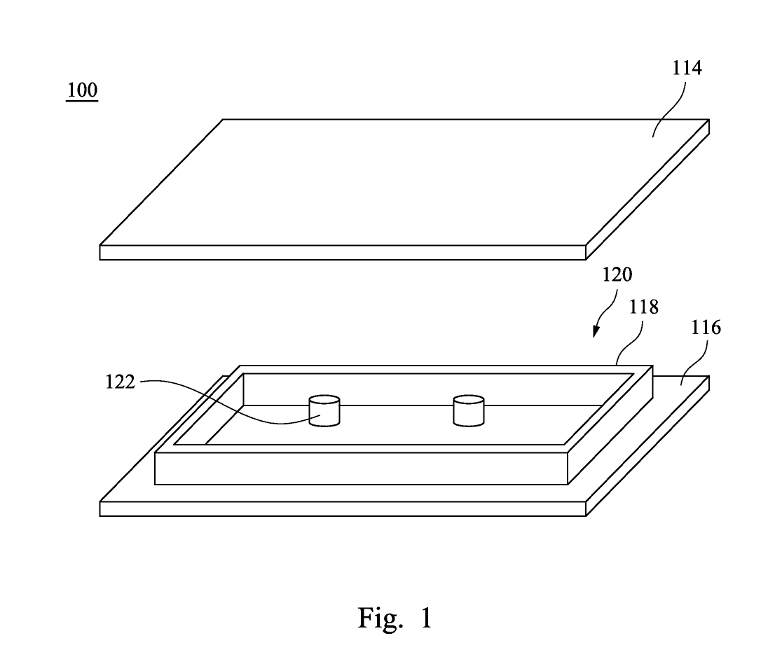

FIG. 1 is an exploded perspective diagram of an acoustic energy inductive device according to an embodiment of the present invention. An acoustic energy inductive device 100 includes a first fabric 114, a second fabric 116, and at least one microphone 122. In the following description, it will be assumed that there is more than one microphone 122 as shown in FIG. 1, but the present invention is not limited in this regard.

The first fabric 114 and the second fabric 116 are disposed parallel to each other and adhered together by a laminating adhesive 118, such that a resonant chamber 120 is formed between the first fabric 114 and the second fabric 116 with an airtight structure. Moreover, the first fabric 114 and the second fabric 116 are made of impermeable material.

According to an embodiment of the present invention, the first fabric 114 is a composite fabric layer with multiple sub-layers. Furthermore, the first fabric 114 and the second fabric 116 are made of a composite neoprene fabric, a composite polyvinyl chloride (PVC) film fabric, a non-woven fabric or combinations thereof.

The resonant chamber 120 is defined by boundaries of the first fabric 114, the second fabric 116, and the laminating adhesive 118. That is, opposing boundaries of the resonant chamber 120 are defined by the first fabric 114 and the second fabric 116, and the other boundaries of the resonant chamber 120 are defined by the surrounding laminating adhesive 118. According to an embodiment of the present invention, a medium in the resonant chamber 120 is air. However, a person having ordinary skill in the art may choose other mediums for the resonant chamber 120 as deemed necessary.

The microphones 122 are disposed in the resonant chamber 120, and the microphones 122 are fixed on one of the first fabric 114 and second fabric 116. In FIG. 1, the microphones 122 are fixed on the second fabric 116. However, a person having ordinary skill in the art may choose a proper location for the microphones 122 as deemed necessary. The microphones 122 are used for converting a sonic signal into an electrical signal, in which types of the microphones 122 include but are not limited to dynamic microphones, condenser microphones, electret condenser microphones or micro electrical-mechanical system microphones. In addition, a person having ordinary skill in the art may choose a proper number of the microphones 122 as deemed necessary.

According an embodiment of the present invention, fabric without disposing the microphones 122 (for example, the first fabric 114 in FIG. 1) is a detective surface for sonic waves. Therefore, the first fabric 114 is regarded as a medium for sonic waves, such that a sonic wave can pass through the first fabric 114 and enter into the resonant chamber 120. Moreover, when the first fabric 114 is hit by an object, a sonic wave caused by such hitting also can pass through the first fabric 114 and enter into the resonant chamber 120.

When a sonic wave passes through the first fabric 114, because the first fabric 114 is elastic and soft, part of the energy of the sonic wave is absorbed by the first fabric 114. Subsequently, the sonic wave enters into the resonant chamber 120. A vibration frequency of the inside medium of the resonant chamber 120 is not only affected by the properties of the medium itself but is also related to the first fabric 114 and the second fabric 116 which form the boundaries of the resonant chamber 120.

After the sonic wave enters into the resonant chamber 120, the remaining part of the sonic wave not absorbed oscillates between the first fabric 114 and the second fabric 116. With the resonant chamber 120, part of the frequency of the sonic wave is absorbed by the first fabric 114 and the second fabric 116, and therefore a specific frequency of the sonic wave can be effectively received by the microphones 122.

On the other hand, when the first fabric 114 is hit by an object, a sonic wave caused by such hitting also can be received by the microphones 122 in the same transmission manner as described above.

With the disposition of the resonant chamber 120, regardless of how a sonic wave is received by the first fabric 114 (i.e., by directly entering there through or caused by hitting), the waveforms of the original sonic wave and the sonic wave ultimately received by the microphones 122 are different. The acoustic energy inductive device 100 of the present invention uses the manner of transmission described above, such that part of the frequency of the sonic wave regarded as noise is absorbed by the fabrics 114, 116 and a specific frequency of the sonic wave is received by the microphones 122. As a result, the effect of filtering the sonic wave is achieved.

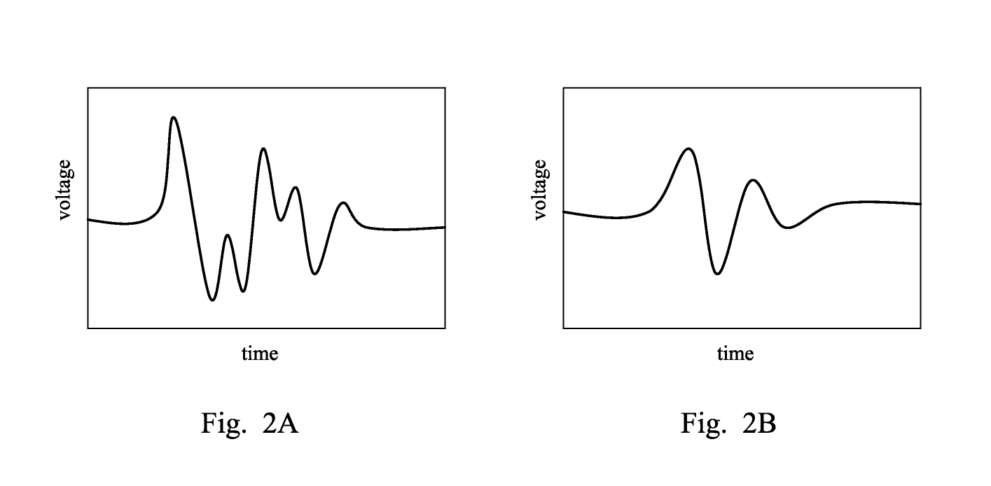

FIG. 2A is a waveform schematic diagram of a sonic signal that has not passed into a resonant chamber of the acoustic energy inductive device of the present invention. FIG. 2B is a waveform schematic diagram of a sonic signal that has passed into the resonant chamber of the acoustic energy inductive device of the present invention. In each of FIG. 2A and FIG. 2B, the horizontal axis represents time, and the vertical axis represents voltage magnitude.

In FIG. 2A, when the sonic wave is recorded directly, the noise is also recorded by microphones, such that the recorded sonic wave has multiple wave packets and forms into a complex waveform. In FIG. 2B, when the sonic wave is recorded through the acoustic energy inductive device 100 (see FIG. 1) of the present invention, because part of the energy of the sonic wave is absorbed by the fabrics (i.e., the first fabric 114 and the second fabric 116 as shown in FIG. 1), the wave packets of the sonic wave received by the microphones 122 (see FIG. 1) are decreased. Therefore, as is evident by a comparison between FIG. 2A and FIG. 2B, the acoustic energy inductive device 100 of the present invention achieves the effect of filtering a wave through decreasing the numbers of wave packets of noise.

In addition, when a sonic wave is received by microphones 122 after passing through the fabrics 114, 116 only and without passing into the resonant chamber 120 (see FIG. 1) of the acoustic energy inductive device 100 of the present invention, the resulting waveform of the sonic wave (not shown) is still complex with multiple wave pockets.

The acoustic energy inductive device 100 of the present invention is a detective device that processes sonic waves using filtering. Therefore, the application of the present invention relates to detecting sonic waves after directly eliminating noise, such that an extra filtering circuit is unnecessary. Furthermore, because the acoustic energy inductive device 100 uses a fabric (i.e., the first fabric 114 and the second fabric 116 as shown in FIG. 1) as a detective surface, a specific type of hitting action can also be detected. The embodiments of the actual applications are described below.

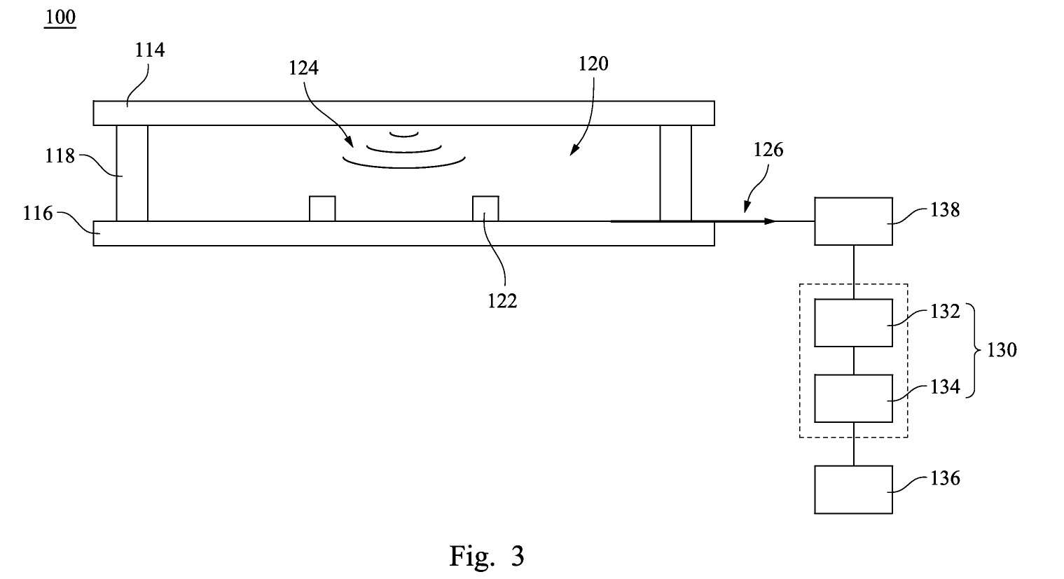

FIG. 3 is a side view of an acoustic energy inductive device according to an embodiment of the present invention. An acoustic energy inductive device 100 includes a first fabric 114, a second fabric 116, and microphones 122. In addition, the acoustic energy inductive device 100 further includes an amplifier 138, a processing circuit 130, and a sensing signal generator 136.

A laminating adhesive 118 is disposed between the first fabric 114 and the second fabric 116 for interconnecting these elements, such that a resonant chamber 120 is formed by the first fabric 114 and the second fabric 116 with an airtight structure. The microphones 122 are disposed in the resonant chamber 120 and fixed on the second fabric 116. It is to be noted that the number of the microphones 122 shown in FIG. 3 is for illustrative purposes only, and a person having ordinary skill in the art may choose a suitable number of the microphones 122 as deemed necessary.

As described above, when a sonic wave directly enters into the resonant chamber 120 or enters into the resonant chamber 120 as a result of a hitting action, after undergoing filtering, a sonic signal 124 is received by the microphones 122 in the resonant chamber 120. The sonic signal 124 is converted into an electrical signal 126 by the microphones 122, and then the electrical signal 126 is inputted into a processing system composed of the amplifier 138, the processing circuit 130, and the sensing signal generator 118.

The amplifier 138 is connected to the microphones 122 and the processing circuit 130. The amplifier 138 amplifies the electrical signal 126 from the microphones 122, and then the amplified electrical signal 126 is inputted into the processing circuit 130.

The processing circuit 130, which includes a converter 132 and a transmission device 134, is used for determining whether to send a control signal according to the electrical signal 126, in which the sending of the control signal is determined by the converter 132 and the transmission device 134.

The converter 132 is used for determining a duration time of the electrical signal 126 in a predetermined level range. The transmission device 134 is used for sending the control signal when the duration time is in a predetermined time range. In addition, the control signal sent from the transmission device 134 of the processing circuit 130 is inputted into the sensing signal generator 136.

Specifically, the sonic wave 124 is filtered by the acoustic energy inductive device 100 of the present invention first. Next, the sonic wave 124 is converted into the electrical signal 126. Finally, the electrical signal 126 is processed by the processing circuit 130. A further description is provided below with reference to the drawings.

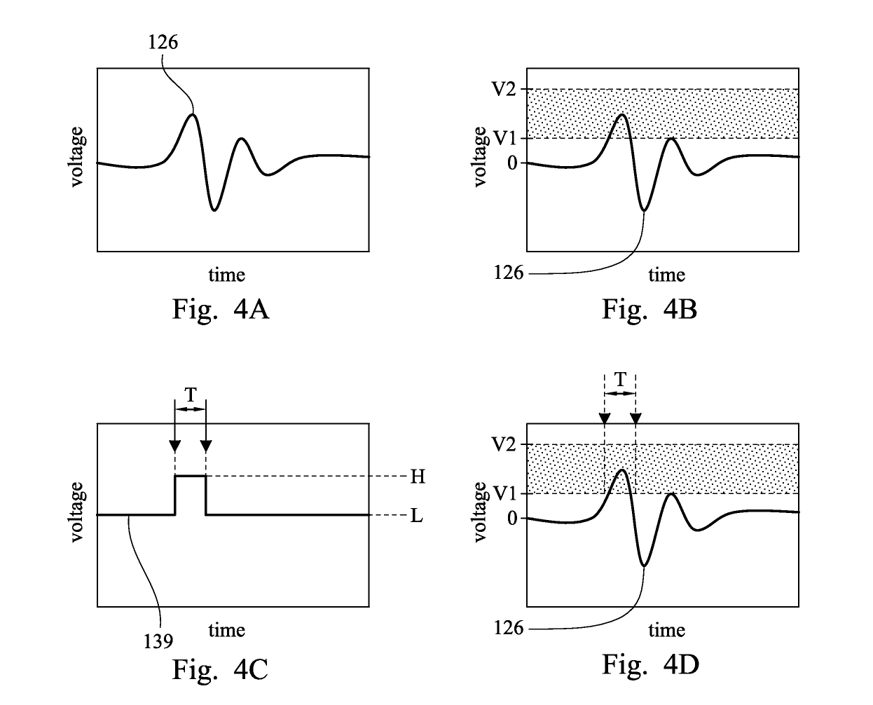

FIG. 4A to FIG. 4D are schematic diagrams of a converting process by a processing circuit of an acoustic energy inductive device of the present invention. In each of FIG. 4A to FIG. 4D, the horizontal axis represents time, and the vertical axis represents voltage magnitude. According to an embodiment of the present invention, the processing circuit 130 (see FIG. 3) of the acoustic energy inductive device 100 (see FIG. 3) of the present invention performs processing after the electrical signal is converted into a square wave.

FIG. 4A is a waveform diagram of the electrical signal 126 after the sonic signal (see FIG. 3) is filtered and amplified. FIG. 4B illustrates the electrical signal 126 in FIG. 4A corresponding to a predetermined level range, in which the predetermined level range is an interval of voltage magnitude shown as a shadow area in FIG. 4B. According to an embodiment of the present invention, a lower limit value V1 of the predetermined level range is about 5 mv, and an upper limit value V2 of the predetermined level range is about 15 mv.

The electrical signal 126 is converted into two signals with different magnitude by the converter 132 (see FIG. 3) of the processing circuit 130, in which the two signals are defined a high level signal H and a low level signal L. The electrical signal 126 in the predetermined level range is converted into the high level signal H, and the electrical signal 126 out of the predetermined level range is converted into the low level signal L. In other words, the portion of the signal that is greater than 5 mv and less than 15 mv is converted into the high level signal H, and the portion of the signal with other magnitudes is converted into the low level signal L as a square wave 139, as shown in FIG. 4C.

Next, the converter 132 of the processing circuit 130 determines a duration time T of the high level signal H of the square wave 139, and the determination result is compared with a predetermined time range. According an embodiment of the present invention, it is determined at this time whether the duration time T is in the predetermined time range, in which the predetermined time range is about 3 μs to 10 μs. In other words, it is determined at this time whether the duration time T of the high level signal H of the square wave 139 is greater than 3 μs or less that 10 μs. Taking FIG. 4C as an example, if the duration time T of the high level signal H of the square wave 139 is 4 μs, the transmission device 134 of the processing circuit 130 will send the control signal since the duration time T of the high level signal H of the square wave 139 is in the predetermined time range. The control signal is sent by the transmission device 134 (see FIG. 3) and received by the sensing signal generator 136 (see FIG. 3). On the other hand, if the duration time T of the high level signal H of the square wave 139 is less than 3 μs or greater than 10 μs, the transmission device 134 will not send the control signal to the sensing signal generator 136.

According to another embodiment of the present invention, the determination can be achieved by the converter 132 of the processing circuit 130 by directly determining the duration time T of the electrical signal 126 which is greater than V1 (5 mv) and less than V2 (15 mv) in the predetermined level range, and the step of converting to the square wave is skipped as shown in FIG. 4D.

Referring to FIG. 3, the sensing signal generator 136 is used for sending a sensing signal according to the control signal. After the sonic wave or the shock wave caused by a hitting action of an object received by the acoustic energy inductive device 100 of the present invention has been filtered, converted, and processed, the sensing signal is sent once a processing condition is satisfied.

However, a person having ordinary skill in the art may choose a proper predetermined level range and predetermined time range as deemed necessary. For example, if detection of a stronger sonic wave is required, the upper value of the predetermined level range can be raised.

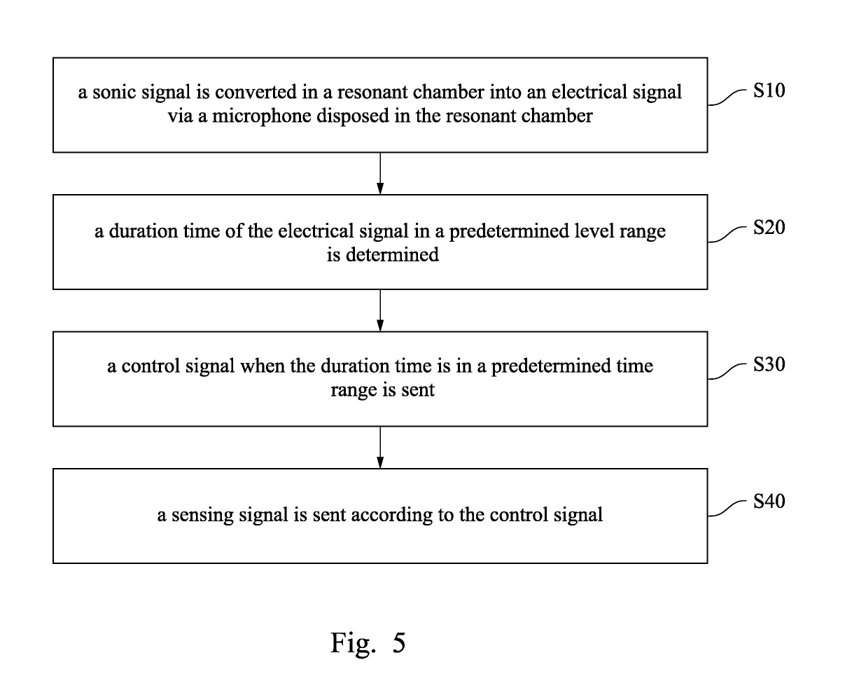

FIG. 5 is a flow chart of a detecting method of the acoustic energy inductive device according to an embodiment of the present invention. A detecting method for inducting an acoustic energy of the present invention includes a number of steps as described below. In Step S10, a sonic signal is converted in a resonant chamber into an electrical signal via a microphone disposed in the resonant chamber. In Step S20, a duration time of the electrical signal in a predetermined level range is determined. In Step S30, a control signal when the duration time is in a predetermined time range is sent. In Step S40, a sensing signal is sent according to the control signal. According to an embodiment of the present invention, a lower limit value of the predetermined level range is about 5 mv and an upper limit value of the predetermined level range is about 15 mv, and the predetermined time range is about 3 μs to 10 μs.

The acoustic energy inductive device of the present invention can be applied to sound detection and object hitting detection, in which the object hitting detection can be further applied in a war game (or survival game) or a shooting competition. The following describes an application of the acoustic energy inductive device of the present invention in object hitting detection.

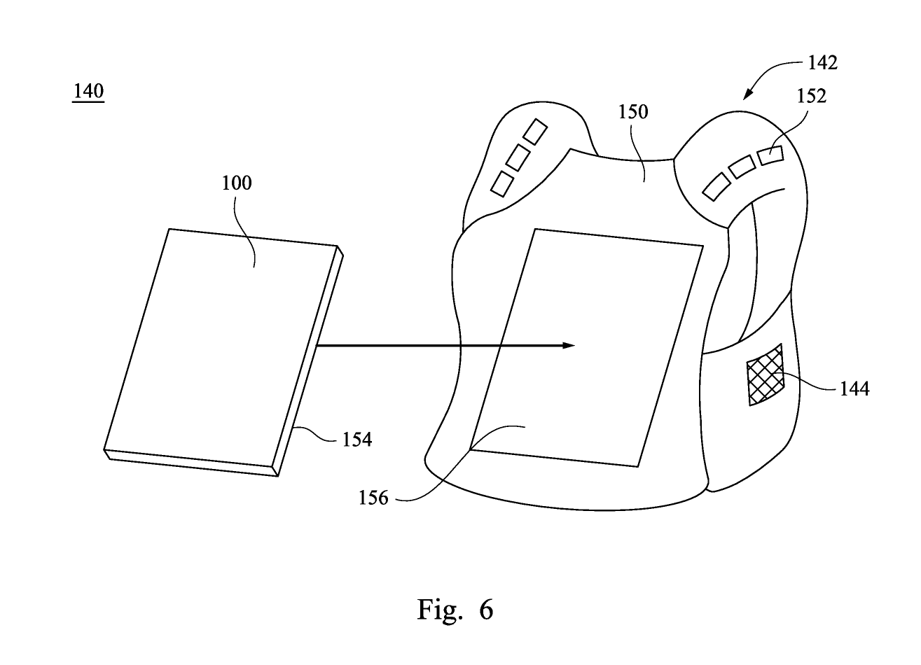

FIG. 6 is a schematic diagram of a wearable equipment according to an embodiment of the present invention. A wearable equipment 140 includes an acoustic energy inductive device 100 and a body 142.

The body 142 includes a vest 150, light emitting diodes (LEDs) 152, a speaker 144, and an adhesive area 156. The acoustic energy inductive device 100 has the same structure as described above and further includes an adhesive surface 154, in which the adhesive surface 154 is disposed on a surface opposite of the detective fabric. According to an embodiment of the present invention, the adhesive area 156 and the adhesive surface 154 are realized using a hook-and-loop fastener assembly, such that the acoustic energy inductive device 100 fixed on the body 142 along an arrow direction can be detached from the body 142.

The vest 150 is suitable for use in war games (or survival games) or in shooting competitions. As described above, the acoustic energy inductive device 100 of the present invention includes the sensing signal generator 136 (see FIG. 3) for sending sensing signals. In present embodiment, the sensing signal generator 136 includes the LEDs 152 and the speaker 144 disposed on the vest 150, and the sensing signals are light and sound signals. When a user wearing the wearable equipment 140 is hit by a specific object (for example, a toy bullet), after a sonic wave produced by the hitting action is filtered, converted, processed and confirmed that the specific object is a toy bullet, light emission by the LEDs 152 or sound production by the speaker 144 is performed for confirming the hit of a toy bullet.

If a hit is caused by another object (for example, a touch by another user), a sensing signal will not be produced due to an error touch, since the acoustic energy inductive device 100 of the present invention includes the processing circuit 130 (see FIG. 3) used for processing. Therefore, the wearable equipment 140 can detect shots by toy bullets, indicate hits by toy bullets, and count points for competition.

For competition requiring determining a hit by a toy bullet, the resulting sonic wave is a detective source of the acoustic energy inductive device 100 of the present invention. Therefore, a restoration time of detector deformation or resistance of a detector is not used in this detection method, and the sonic wave is confirmed by a series of processes. Furthermore, even when the wearable equipment 140 is hit continuously by toy bullets, the acoustic energy inductive device 100 still can clearly identify the different hits.

Moreover, the acoustic energy inductive device 100 mainly composed of fabrics (i.e., the first fabric 114 and the second fabric 116 as shown in FIG. 1) does not burden the user wearing the equipment 140 with much weight. Furthermore, the acoustic energy inductive device 100 is lightweight and elastic, such that the user still can compete with agility.

In addition, the structure of the acoustic energy inductive device 100 of the present invention mainly composed of fabrics 114, 116 is simple, such that the size of the acoustic energy inductive device 100 can be easily varied. Thus, in addition making the e equipment in a vest type of configuration, the acoustic energy inductive device 100 can be applied to various other types of wearable equipment.

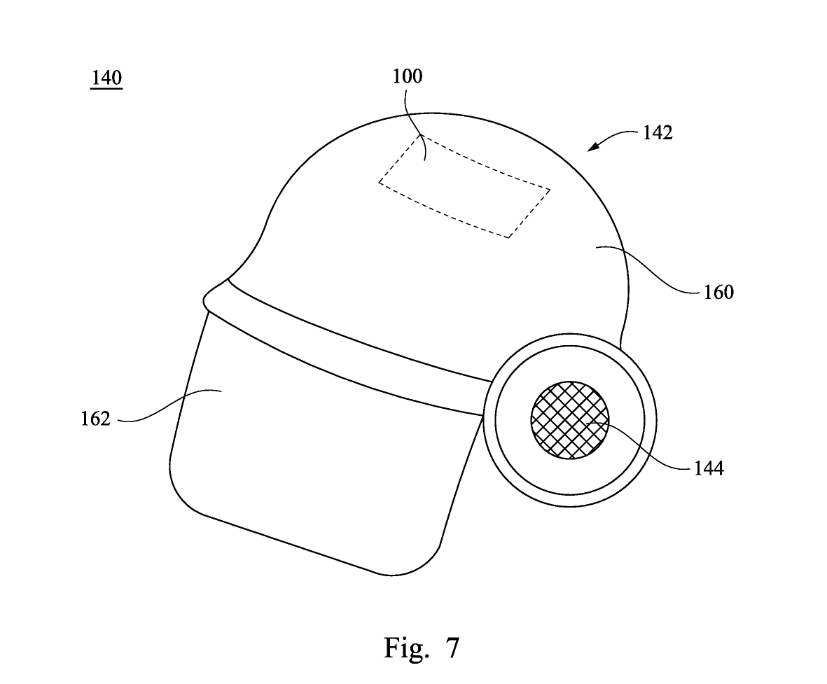

FIG. 7 is a schematic diagram of a wearable equipment according to another embodiment. A wearable equipment 140 includes an acoustic energy inductive device 100 and a body 142.

The body 142 includes a helmet 160, a mask 162, and a speaker 144. The acoustic energy inductive device 100 is disposed inside of the helmet 160. Hook-and-loop fastener assembly is disposed at a side of the acoustic energy inductive device 100 and the inside of the helmet 160, such that the acoustic energy inductive device 100 is detachably disposed on the body 142.

The speaker 144 is driven according to the control signal sent by the processing circuit 130 (see FIG. 3) of the acoustic energy inductive device 100, in which the speaker 144 is a sensing signal generator 136 (see FIG. 3) for producing sound as the sensing signal when the user is hit by a toy bullet.

In present embodiment, when the helmet 160 or the mask 162 is hit by a toy bullet, the vibration or the sonic wave can be transmitted to the acoustic energy inductive device 100 disposed inside of the helmet 160 due to the good mechanical wave conducting property of the helmet 160 or the mask 162, such that the vibration or the sonic wave can be filtered, converted, and processed.

However, a person having ordinary skill in the art may choose a suitable body 142 for application to the wearable equipment 140 as deemed necessary. In addition to the vest and the helmet, gloves, boots, and protective clothing used commonly in survival competitions also can serve as the body 142. Furthermore, in the case of shooting competition applications, the acoustic energy inductive device 100 can be disposed on a target for shooting.

Therefore, the acoustic energy inductive device 100 of the present invention can be applied to wearable equipment for effectively identifying hitting by toy bullets, and the sensing signals of light emission and/or sound production, or as used to count points are generated after hitting by the toy bullets.

According to the foregoing embodiments, with the structure of the resonant chamber 120 (see FIG. 3) formed by fabrics (i.e., the first fabric 114 and the second fabric 116 as shown in FIG. 1) in the acoustic energy inductive device 100 of the present invention, the effect of filtering waves without the use of an extra circuit is achieved by the acoustic energy inductive device 100. Therefore, when the acoustic energy inductive device 100 is applied to sonic wave detection, the noise of a sonic wave is filtered such that a specific frequency of the sonic wave is received.

When a sonic wave is detected by the acoustic energy inductive device 100 formed by fabrics 114, 116 the noise and vibration produced by a background environment are absorbed by the fabrics 114, 116 such that the main sonic wave of the source is received by the microphones 122 (see FIG. 3). Moreover, when the sonic wave has to be amplified by the amplifier 138 (see FIG. 3) due to a weak magnitude of the sonic source, the resulting sonic signal does not become indistinguishable from the noise amplified since the sonic signal is effectively filtered by the acoustic energy inductive device 100.

In addition, a signal is further converted and processed by the processing circuit 130 (see FIG. 3) of the acoustic energy inductive device 100 of the present invention, such that detection of a specific sonic wave is achieved. Moreover, toy bullets can be effectively detected through the combination of the acoustic energy inductive device 100 and the wearable equipment (e.g., a vest or helmet), and such a combination of the wearable equipment and the acoustic energy inductive device 100 with lightweight and flexible properties ensures that the user remains agile. Furthermore, because the detective source is a sonic wave, the acoustic energy inductive device 100 can effectively identify different hits.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An acoustic energy inductive device, comprising:
a first fabric;
a second fabric combined with the first fabric, wherein a resonant chamber is formed between the first fabric and the second fabric; and
at least one microphone disposed in the resonant chamber for converting a sonic signal in the resonant chamber into an electrical signal;
wherein the first fabric and the second fabric are made of impermeable material.

2. The acoustic energy inductive device of claim 1, wherein the first fabric is a composite fabric layer with multiple sub-layers.

3. The acoustic energy inductive device of claim 1, wherein the first fabric is made of a composite neoprene fabric, a composite polyvinyl chloride (PVC) film fabric, a non-woven fabric or combinations thereof.

4. The acoustic energy inductive device of claim 1, wherein the second fabric is made of a composite neoprene fabric, a composite polyvinyl chloride (PVC) film fabric, a non-woven fabric or combinations thereof.

5. The acoustic energy inductive device of claim 1, further comprising:
a processing circuit for determining whether to send a control signal according to the electrical signal.

6. The acoustic energy inductive device of claim 5, further comprising:
a sensing signal generator for sending a sensing signal according to the control signal.

7. The acoustic energy inductive device of claim 5, wherein the processing circuit comprises:
a converter for determining a duration time of the electrical signal in a predetermined level range; and
a transmission device for sending the control signal when the duration time is in a predetermined time range.

8. The acoustic energy inductive device of claim 1, further comprising:
an amplifier for amplifying the electrical signal.

9. A wearable equipment, comprising:
a body; and
the acoustic energy inductive device of claim 1, wherein the acoustic energy inductive device is disposed on the body.

10. The wearable equipment of claim 9, wherein the body is a vest.

11. The wearable equipment of claim 9, wherein the body is a helmet.

12. The wearable equipment of claim 9, wherein the acoustic energy inductive device is detachably disposed on the body.

13. A method for inducting an acoustic energy, comprising:
converting at least one sonic signal in a resonant chamber into an electrical signal via a microphone disposed in the resonant chamber, wherein the resonant chamber is formed between a first fabric and a second fabric.

14. The method of claim 13, further comprising:
determining whether to send a control signal according to the electrical signal; and
sending a sensing signal according to the control signal.

15. The method of claim 14, wherein determining whether to send a control signal comprises:
determining a duration time of the electrical signal in a predetermined level range; and
sending the control signal when the duration time is in a predetermined time range.

16. The method of claim 15, wherein a lower limit value of the predetermined level range is about 5 mv, and an upper limit value of the predetermined level range is about 15 mv.

17. The method of claim 15, wherein the predetermined time range is about 3 μs to 10 μs.
